(19) United States
(12) Patent Application Publication
(10) Pub. No.: US 2016/0267361 A1
(43) Pub. Date: Sep. 15, 2016

(54) Method and apparatus for adaptive model network on image recognition

(71) Applicant: Pingping Xiu, Santa Clara, CA (US)

(72) Inventor: Pingping Xiu, San Mateo, CA (US)

(21) Appl. No.: 15/069,905

(22) Filed: Mar. 14, 2016

Related U.S. Application Data
(63) Continuation of application No. 62/133,356, filed on Mar. 14, 2015.

(51) Int. Cl. G06K 9/66; G06K 9/62

(52) U.S. Cl. CPC G06K 9/66; G06K 9/6265; G06K 9/6227

(57) ABSTRACT

Techniques for forming, designing, generating or building up recognizers using recursive qualifications are described, where the recognizers can be used in any devices or systems with recognition capabilities, such as robotic vision systems, motion detections, artificial intelligence and driverless vehicles. Through respective and recursive observations on a set of actual data, recognizers are generated to reduce the inconsistencies among the observations to produce better recognition accuracies.

### CROSS-REFERENCE TO RELATED APPLICATION

This application claims the benefits of U.S. Provisional Application No. 62/133,356, filed Mar. 14, 2015, and entitled “Adaptive Model Network on Image Recognition”, which is hereby incorporated by reference for all purposes.

### BACKGROUND OF THE INVENTION

1. Field of the Invention

The present invention is related to the area of pattern recognition and more particularly, related to processes, systems, architectures and software products for building up recognizers using recursive qualifications, where the recognizers can be used in any devices or systems with vision capabilities, such as robotic vision systems, motion detections, artificial intelligence and driverless vehicles.

2. Description of Related Art

Pattern recognition is a branch of machine learning that focuses on the recognition of patterns and regularities in data, although it is in some cases considered to be nearly synonymous with machine learning. Pattern recognition systems are in many cases trained from labeled “training” data (supervised learning), but when no labeled data are available other algorithms can be used to discover previously unknown patterns (unsupervised learning).

In machine learning, pattern recognition is the assignment of a label to a given input value. An example of pattern recognition is classification, which attempts to assign each input value to one of a given set of classes (e.g., determine whether an object in an image is a human being or a structure). However, pattern recognition is a more general problem that encompasses other types of output as well. Other examples are regression, which assigns a real-valued output to each input; sequence labeling, which assigns a class to each member of a sequence of values (e.g., part of speech tagging, which assigns a part of speech to each word in an input sentence); and parsing, which assigns a parse tree to an input sentence, describing the syntactic structure of the sentence.

Pattern recognition has been encountering lots of challenges over the past several decades. The major challenges are: how to find a good feature set that represents the data to provide good discriminative power; how to acquire a sufficient amount of oracle data (i.e., data with labels that indicate true nature of the data) for a pattern recognition system to learn from; and how to make the oracle data representative to data in real applications so that the learnings on oracle data can be applied to real applications.

Some of the major problems with the latest pattern recognition software or systems are that they rely on the assumption that a training dataset is representative to a testing dataset, which in practice is often not true; when new data deviates from a training set, an algorithm, if any adaptation features are implemented, relies heavily on domain specific knowledge. For example, font-adaptive optical character recognition will have to provision different fonts' classifier so that all of them are applied simultaneously to the target, with the best one picked. This requires precise tuning of the workflow, which is specific to font adaptation, and in general is difficult to be re-used for other domain's adaptation algorithm design.

Thus there is a great need for recognizers that can be formed, generated and built up quickly with high accuracy to reduce the inconsistencies among different models (observations) to produce better recognition accuracies.

### SUMMARY OF INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to processes, systems, architectures and software products for forming, designing, generating or building up recognizers using recursive qualifications, where the recognizers can be used in any devices or systems with recognition capabilities, such as robotic vision systems, motion detections, artificial intelligence and driverless vehicles. According to one aspect of the present invention, an image pattern recognition process, also referred to adaptive model network (AMN) herein, is designed to generate a set of image recognizer models or recognizers based on a set of input data (e.g., image data), select and combine a confident subset of the recognizers to interpret the image data, and output a proposed label therefor.

According to another aspect of the present invention, AMN is designed to combine existing image recognition techniques in a model network, and adapt the model network to reduce the inconsistencies among different models (observations) to produce better recognition accuracies. One of the major differences from a standard pattern recognition process is that AMN does not require a training set to be representative of a testing set (actual data set); rather it adapts itself to testing data by leveraging the intrinsic prior knowledge that a valid data set should get consistent interpretations over valid but different observations.

According to still aspect of the present invention, depending on a defined resolution, each of the recognizers in the AMN can be subsequently dividable in a sense that a recognizer can be represented in a tree structure with one node leading to multiple branches, each of the branches ends with a node. In other words, a recognizer may include a plurality of sub-recognizers, each of the sub-recognizers may include a plurality of next sub-recognizers, and each next sub-recognizers may include a plurality of further dividable sub-recognizers till permitted by the defined resolution.

According to yet aspect of the present invention, the AMN is designed to update the recognizers by recursively testing the recognizers, their respective sub-recognizers, next sub-recognizers and/or further dividable sub-recognizers. As a result, the AMN reduces inconsistencies on each recursion level, and outputs a result when a top level has a set of observations producing consistent interpretations to a target data set.

Various embodiments may be implemented as a method, a software product, a service and a part of a system. According to one embodiment, the present invention is a method for generating recognizers for pattern recognition, the method comprises: receiving in a computing device a set of initial recognizers, wherein the recognizers are generated from a set of training data not required to be representative of a set of actual data. Each of the recognizers is dividable to form a set of sub-recognizers and each of the sub-recognizers is further dividable to form a set of next sub-recognizers till a predefined resolution on the recognizers. The method further comprises: performing observations on the set of input data received in the computing device in accordance with the recognizers; and generating recursively and respectively subsequent observations with reduction of inconsistencies on each recursion level, when one of the observations is determined uncertain, wherein a recursion stops when a top level has a set of observations producing consistent interpretations on the set of input data. A recursion stops when a top level has a set of observations producing consistent interpretations on the set of input data. Meanwhile the recognizers are recursively and respectively updated by discarding one or more of the recognizers, the sub-recognizers or the further dividable sub-recognizers, and adding new recognizers, sub-recognizers or further dividable sub-recognizers generated based on the input data.

According to another embodiment, the present invention is a computing device for generating recognizers for pattern recognition, the computing device comprises: an input receiving a set of actual data, where the actual data is captured by a source (e.g., a camera), a memory for storing code, a processor coupled to the memory and executing the code to perform operations of: loading a set of initial recognizers in the memory, wherein the recognizers are generated from a set of training data not required to be representative of the set of actual data, each of the recognizers is dividable to form a set of sub-recognizers and each of the sub-recognizers is further dividable to form a set of next sub-recognizers till a predefined resolution on the recognizers. The operations further include generating observations on the set of input data received in the computing device in accordance with the recognizers; and generating recursively and respectively subsequent observations on the set of input data with reduction of inconsistencies on each recursion level, when one of the observations is uncertain, wherein a recursion stops when a top level has a set of observations producing consistent interpretations on the set of input data.

One of the objectives in the present invention is to provide a mechanism that adapts itself to testing data by leveraging the intrinsic prior knowledge that a valid data set should get consistent interpretations over valid but different observations.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1A shows an example in which images are captured and provided as an input to a recognition system (not shown) employing one embodiment of the present invention;

FIG. 1B shows exemplary internal construction blocks of a computing device in which one embodiment of the present invention may be implemented and executed;

FIG. 2 shows a state diagram describing how the recognizers are generated according to one embodiment of the present invention;

FIG. 3 shows an exemplary structure of carrying out a set of observations with a plurality of recognizers;

FIG. 4 shows a structure of measuring n observation results i₁, i₂, . . . , iₙ;

FIG. 5 shows a diagram of a transition from state O to state Sₖ, where it is assumed that observation Oₖ is uncertain after the logical operation or the measurement on one of the disagreements d₁, d₂, . . . , dₙ is beyond a threshold;

FIG. 6 shows a diagram in which a recognizer is discarded as a result of an observation Oₖ;

FIG. 7 shows a diagram in which one or more new recognizers are added into the library of the recognizers when new features or characteristics of the actual data are not recognized by any of the existing recognizers;

FIG. 8 shows a diagram in which a recognizer used for observation Oₖ is discarded; and

FIG. 9 shows a diagram of using a transformed data set. The original data set t is applied to the observations at state O.

### DETAILED DESCRIPTION OF THE PREFERRED EMBODIMENTS

The present invention is related to processes, systems, architectures and software products for forming, designing, generating or building up recognizers using recursive qualifications. In one perspective, a process, referred herein as adaptive model network (AMN), is designed to update the recognizers by recursively testing the recognizers, their respective sub-recognizers, next sub-recognizers and/or further dividable sub-recognizers, up to a defined resolution. As a result, the AMN reduces inconsistencies on each recursion level, and outputs a result when a top level has a set of observations producing consistent interpretations on a target data set.

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase in “one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

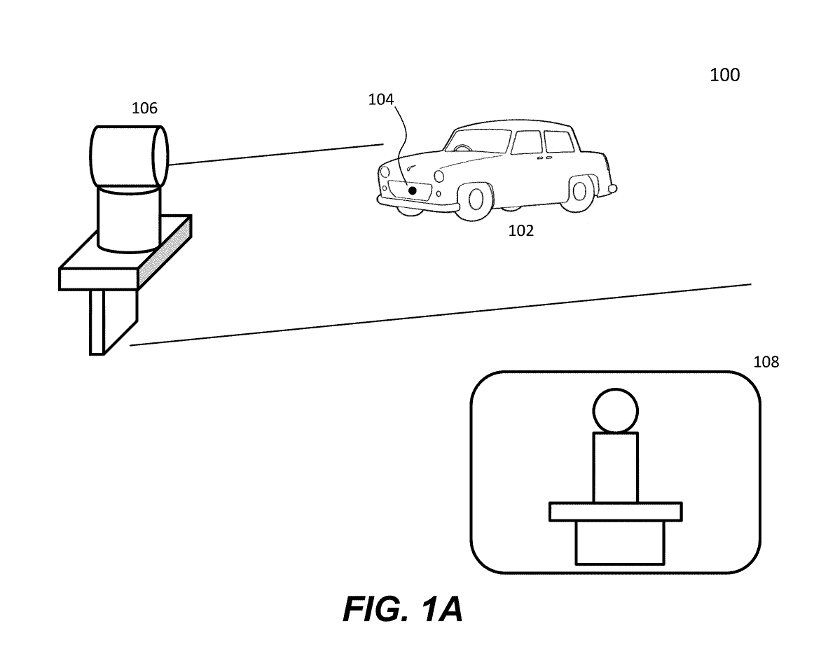

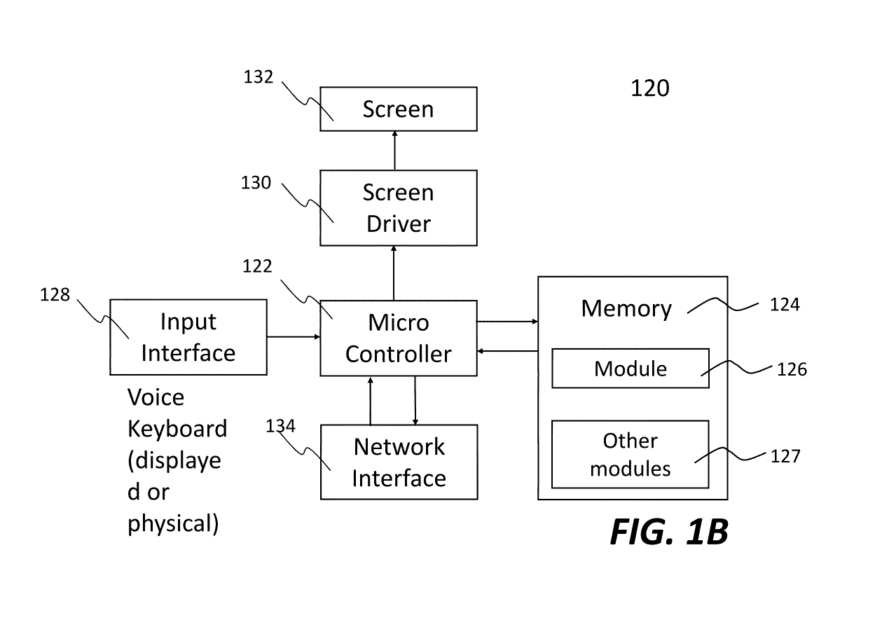

Embodiments of the present invention are discussed herein with reference to FIGS. 1A-9. However, those skilled in the art will readily appreciate that the detailed description given herein with respect to these figures is for explanatory purposes as the invention extends beyond these limited embodiments. Referring now to FIG. 1A, it shows an example 100 in which images are captured and provided as an input to a recognition system (not shown) employing one embodiment of the present invention. The example 100 shows a driverless vehicle or a vehicle with autopilot capability 102 is equipped with a vision system that has one or more cameras 104. While on road, one of the cameras 104 on a front of the vehicle 102 is caused to capture scenes far ahead of the vehicle 102, generating a stream of images. After the images are processed, corresponding image data is generated and provided to the recognition system for pattern recognition.

It is assumed that an object 106 is in a scene captured by the camera 104. The object 106 appears in an image 108. One of the objectives in the recognition system is to determine whether the object 106 is a structure or a human being (possibly crossing a street). To determine what the object is, the recognition system shall be equipped with a set of recognizers that not only interprets the image data correctly but also expands the already generated recognizers with one or more recognizers based on the provided image when there is a need. It is evident to those skilled in the art the recognizers must be robust but also accurate to interpret the image correctly.

FIG. 1A shows that the recognition functions in the recognition system can be completed entirely in the vehicle 102. Those skilled in that art can appreciate that the recognition functions may also be completed in a cloud based infrastructure, taking the advantages of superior or unlimited computing power in servers.

FIG. 1B illustrates an internal functional block diagram 120 of an exemplary computing device that may be used in the vehicle 102 of FIG. 1A to provide the pattern recognition functions in the recognition system. Alternatively, the functional block diagram 120 may also represent a server. The computing device 120 device includes a microprocessor or microcontroller 122, a memory space 124 (e.g., RAM or flash memory) in which there is a module 126, an input interface, a screen driver 130 to drive a display screen 132 and a network interface 134. The module 126 may be implemented as firmware or an application implementing one embodiment of the present invention, and downloadable over a network or a designated server. According to one embodiment of the present invention, the module includes code for generating recursively a set of recognizers based on a set of training data and expanding the recognizers based on the actual data from actual input data.

The input interface 128 includes one or more input mechanisms. A user may use an input mechanism to interact with the device 120 by entering a command to the microcontroller 122. Examples of the input mechanisms include a microphone or mic to receive an audio command and a keyboard (e.g., a displayed soft keyboard) to receive a click or texture command. Another example of an input mechanism is a camera provided to generate images, where the image data from the images are used for subsequent processing with other module(s) or application(s) 127. In the context of the present invention, some of the image data are subsequently provided to the recognition system for interpretation.

The driver 130, coupled to the microcontroller 122, is provided to take instructions therefrom to drive a display screen 132. In one embodiment, the driver 130 is caused to drive the display screen 132 to display an image or images or play back a video. The network interface 134 is provided to allow the device 120 to communicate with other devices via a designated medium (e.g., a data network).

One of the objects, advantages and benefits in the present invention is to combine existing image recognition techniques in a model network, and adapt the model network to reduce the inconsistencies among different models (observations) to produce better recognition accuracies. According to one embodiment, the recognizers are generated or updated in a recursive manner with reduction of inconsistencies on each recursion level, the recursion stops when a top level has a set of observations producing consistent interpretations to the target.

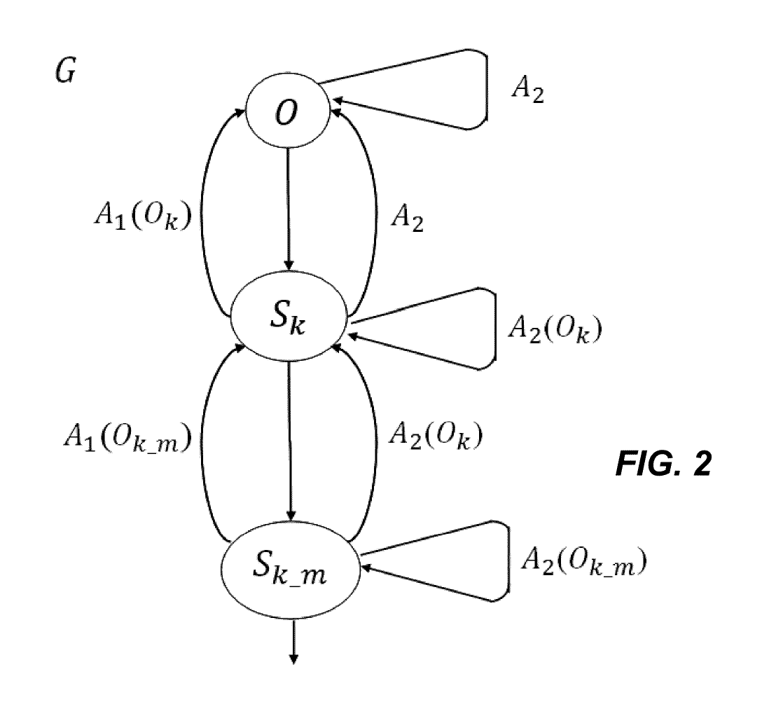

FIG. 2 shows a state diagram 200 describing how the recognizers are generated according to one embodiment of the present invention. It is assumed a top level labeled as state O, state Sₖ is the secondary level to state O, and Sₖ is the secondary level to state Sₖ and the third level to state O. The state diagrams for state O, state Sₖ and Sₖ_{_}ₘ are identical. FIG. 2 shows a state diagram of three levels. The level of state Sₖ_{_}ₘ can be further expanded downwards to a predefined resolution N. The transitions from a state are identical, namely the transitions of state Sₖ appears the same to state O but in the k-th observation in O. Likewise, Sₖ_{_}ₘ is the m-th observation in Sₖ, where m is a finite integer number controlled by an integer or the predefined resolution N. The predefined resolution N is defined depending on application. In general, the higher the predefined resolution N is, the longer it takes to generate the recognizers, but the more precise the recognizers become given the same computing power. According to one embodiment, the predefined resolution N is set to be 6 in a general robotic vision system while the predefined resolution N is set to be 4 for vehicle application.

As will be further described below, whenever one of the observations in state O is uncertain, state O goes to Sₖ. State Sₖ is caused to go on state Sₖ_{_}ₘ when one of the observations in state Sₖ encounters some uncertainty (e.g., comparing with a threshold). At each of the states, Sₖ or Sₖ_{_}ₘ, the recognizers are verified or updated by removing one or/and adding a new one. State, Sₖ or Sₖ_{_}ₘ then returns back to a previous state, as such the state diagram 200 forms a recursive loop to fine tune or update and generate the recognizers for recognition on a given set of data.

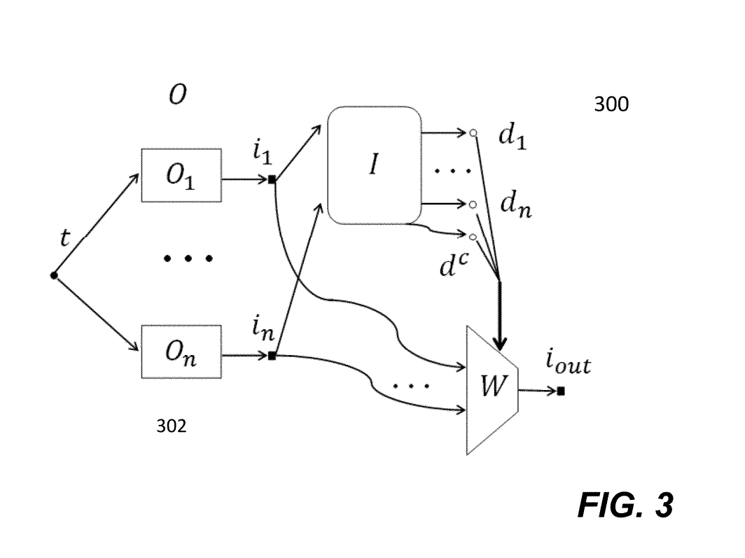

FIG. 3 shows an exemplary structure 300 of carrying out a set of observations with a plurality of recognizers. According to one embodiment, a set of recognizers is provided based on a set of training data. Depending on application, the training data may be initially provided by a library or formed by a user instructed to make manual observations, perform some predefined actions or other acts to ensure that that the recognizers initially make meaningful observations or render meaningful decisions. For example, in the case of autopilot, image data representing certain streets and corresponding recognizers are provided. When actual street image data is received, the recognizers are updated and expanded with new recognizers. Similarly, in the case of motion detection, a user is typically instructed to perform a set of predefined movements to generate a set of training data and a corresponding set of recognizers. These initial recognizers are then updated and expanded in accordance with real motions made by the user in conjunction with a scene (e.g., virtual reality or video game). However, one of the important features in the present invention is that the training data is not required to be representative of a set of actual data. An initial set of recognizers will be updated, expanded and generated over the course of one or more recursive testing on the recognizers, a set of sub-recognizers thereof, and next sub-recognizers till a predefined resolution on the recognizers. In any case, the initial set of recognizers is considered as a seed for the state diagram 200 to proceed.

As shown in FIG. 3, a target data set t is produced from a source (e.g., a camera, a motion controller, or a set of sensors) and applied to n different observations 302. These n different observations 302 are operated on the data set t based on n or more different recognizers. It should be noted that each of the recognizers is not necessarily a single item representing one feature. In general, a recognizer is a collection of items representing certain features or characteristics, and can be further divided into sub-recognizers, where each of the sub-recognizers is a collection of items representing different or less features or characteristics. Again each of the sub-recognizers can be further divided to next sub-recognizers, each representing a collection of different or less features or characteristics. The level of this division is controlled by the predefined resolution N. To avoid obscuring important aspects of the present invention, the operation of the observations 302 is not to be further described herein. Those skilled in the art understand how the observation 302 is performed in accordance with an application. One commercially available example for optical character recognition (OCR) is an engine from Tesseract that performs the observations based on a set of recognizers.

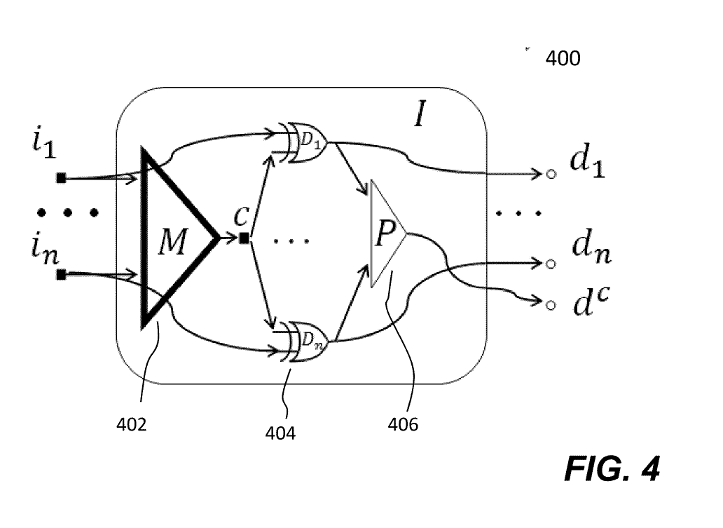

These n different observations 302 produce n results i₁, i₂, . . . , iₙ. Mathematically, they are often expressed in vectors. Ignoring the exact representation of the n results, these n results are coupled to a statistical operation (M) 402 as shown in FIG. 4. In one embodiment, the statistic operation 402 is defined to find a median C among the n results. The median C is then applied to a logical operation 404 with each of the n results from the observations 302. In one embodiment, the logical operation 404 is defined as XOR. In other words, the median C is logically compared with each of the n results to produce n comparisons d₁, d₂, . . . , dₙ with respect to the median C. When the logical operation XOR is used, the median C is XOR-operated with each of the n results to produce n distance or disagreements d₁, d₂, . . . , dₙ that are at the same time supplied to a comparator 406 to produce an overall measurement d^{c}. As such, a measurement can be carried out among the results.

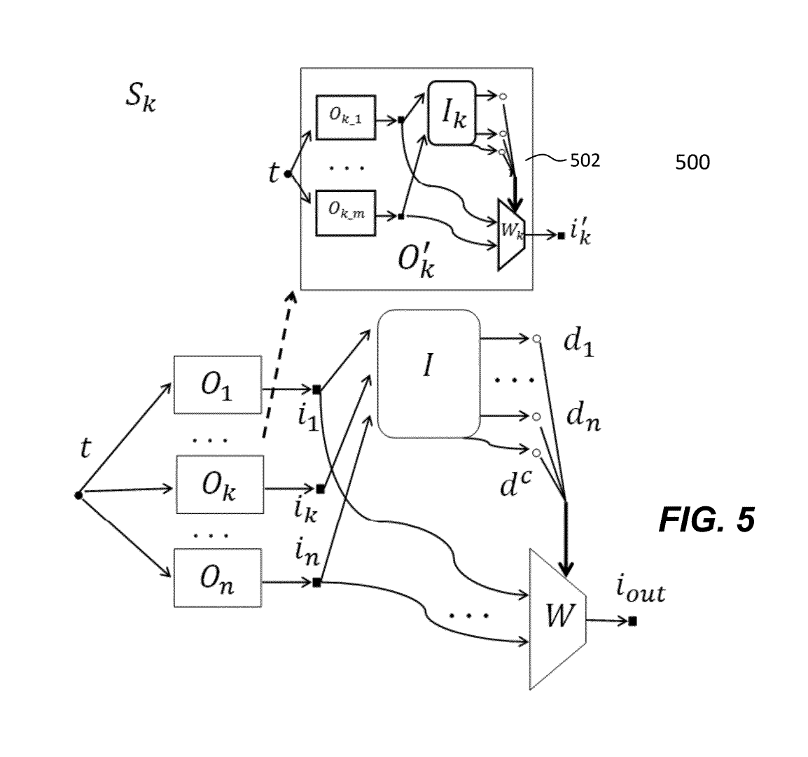

As shown in FIG. 2, state O is transitioned to state Sₖ when one of the observations at level O is uncertain (e.g., beyond a threshold). FIG. 5 shows a diagram 500 of a transition from state O to state Sₖ , where it is assumed that observation Oₖ is uncertain after the logical operation or the measurement on one of the disagreements d₁, d₂, . . . , dₙ is beyond a threshold, causing state O to transition to state Sₖ. At state Sₖ, similar tests are carried out with a set of corresponding sub-recognizers. It is assumed that the observation Oₖ is determined to be uncertain, the observation Oₖ is further carried respectively with the sub-recognizers as shown in a comparison operation 502. It shall be noted that the comparison operation 502 is substantially similar to the operation shown in FIG. 4. In other words, the same structure and same operation may be used to carry out with different inputs and different recognizers or same inputs and different recognizers.

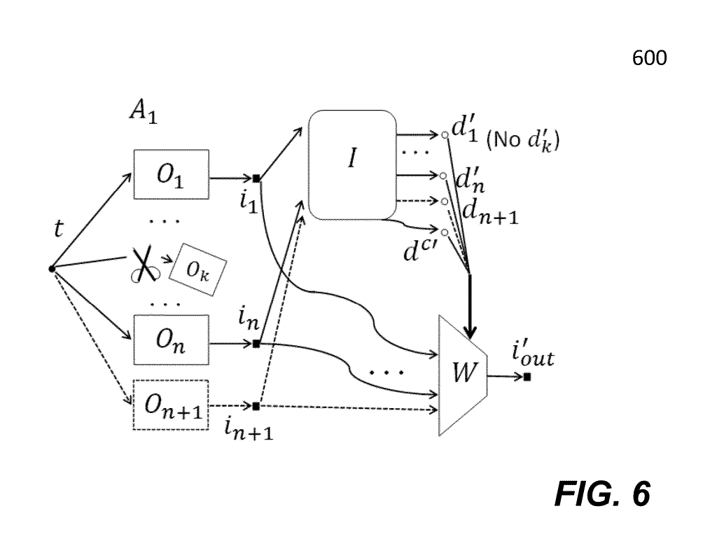

FIG. 6 shows a diagram 600 in which a recognizer is discarded as a result of an observation Oₖ. It is assumed that the observation Oₖ is uncertain. The recognizer used for observation Oₖ is then further tested at state Sₖ. When the discrepancies or measurements from an operation 602 (e.g., comparator W) are significantly apart from a threshold at a recursion level, the recognizer can be further tested with sub-recognizers thereof or simply discarded when reaching the resolution of the recognizer. It is assumed that the resolution is reached, then the recognizer is discarded as illustrated in FIG. 5.

At the same time, one or more new recognizers can be added into the library of the recognizers when new features or characteristics of the actual data are not recognized by any of the existing recognizers. These new recognizers may be used for observation At At a result, state Sₖ returns to state O, labeled as A₂ in FIG. 2. Similarly, when the n different observations at state O are all certain, new recognizers may still be added to expand the original library of recognizers, also labeled as A₂ in FIG. 2.

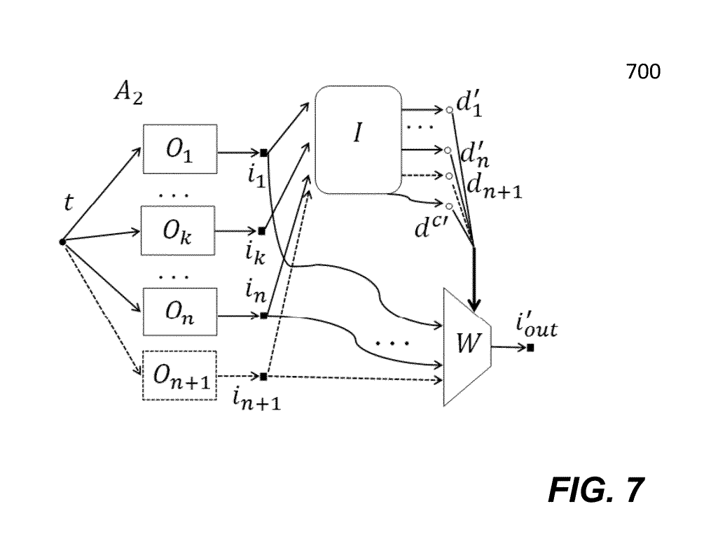

FIG. 7 shows a diagram 700 in which one or more new recognizers are added into the library of the recognizers when new features or characteristics of the actual data are not recognized by any of the existing recognizers. These new recognizer shall be used for observation Oₙ₊₁.

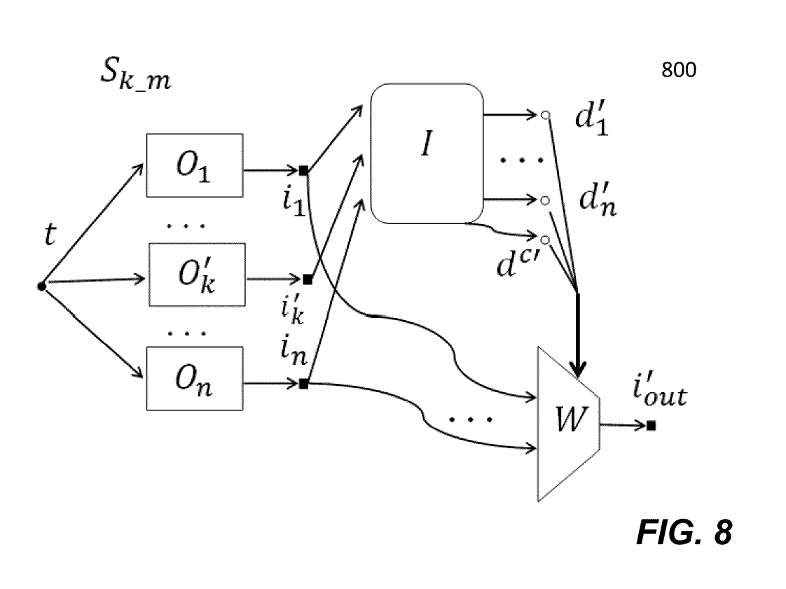

FIG. 8 shows a diagram 800 in which a recognizer used for observation Oₖ is discarded. The recognizer being discarded may be a result of the limit by the predefined resolution N or a failure in a subsequent state. In other words, the recognizer represents features or characteristics that are not found in the actual data set or an observation with the recognizer fails with certain, and further tests on sub-recognizers of the recognizer could also have failed.

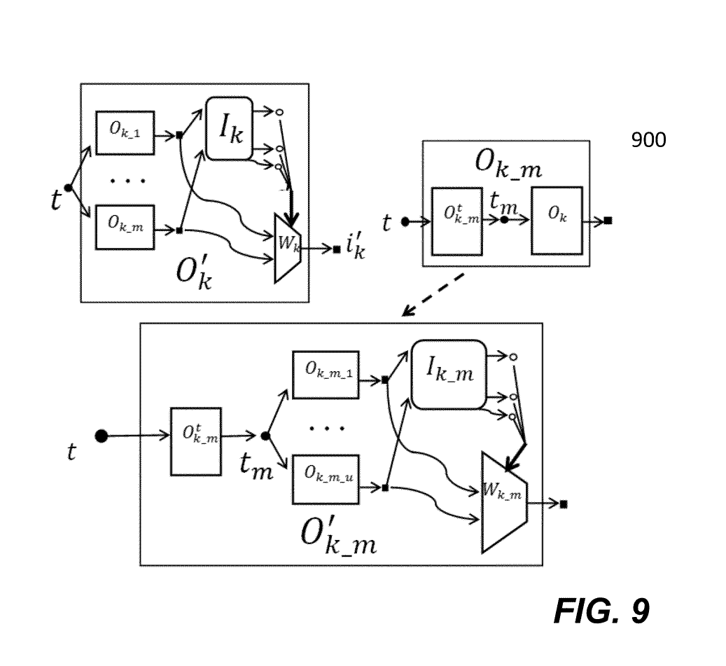

FIG. 9 shows a diagram of using a transformed data set. The original data set t is applied to the observations at state O. Before the original data set t is applied to one of the observations, the original data set t is transformed to a data set tₘ. Depending on application, there may be many ways to transform the original data set t to a transformed data set tₘ. The purpose is to facilitate the observation with respect to one or more recognizers.

According to one embodiment, a data transformation may be used at any recursion level to facilitate the observation with respect to one or more recognizers.

Referring to FIG. 2 and FIG. 5, in state O, multiple observations are recognizing the same target t. Results are obtained and overall disagreement d^{c} is computed. If d^{c} is lower than a threshold, the procedure ends with the results form the observations passed as an output. On the other hand, if d^{c} is higher than the threshold, then the reduction of inconsistency for O begins. It may pick the k-th observation as the one that causes high d^{c} and expand the k-th observations to the same multi-observation structure as state O does, with Sₖ is the resulting topology.

In state Sₖ, the overall disagreements among its observations are also computed: dₖ^{c}. If it is higher than a pre-set threshold, then its own reduction of inconsistency is trigged and drives the adaptation for Sₖ. Since the Sₖ is a recursive process of O, it can expand one of its own observation (m) into a set of observations, reaching a state Sₖ_{_}ₘ.

If the dₖ^{c} in Sₖ cannot be reduced anymore by any means, then return to the state O. The return to the state O has two possible paths, based on the condition: if dₖ^{c} is higher than its threshold, A₁ operation will be conducted, which will remove the current Sₖ; otherwise Sₖ is kept. New observations are performed after returning from Sₖ.

It should be noted that the observations on each level may be applied in parallel on the same target with outlier selected. If an outlier deviates enough, more observations can be trigged so that more evidences can be obtained on whether there is a need to adopt the outlier, or ignore it.

The state transition graph shown in FIG. 2 makes adaptations to the initial stage O to expand the model (observation) network. It is an adaptive process that adjusts the topology (including retrain observations) to get better overall consistency on each level.

At stage O, where multiple observations {Oₖ, k in 1. . . n} are recognizing the same target t, and output a set of interpretations {iₖ, k in 1 . . . n}. Then, the interpretation set {iₖ, k in 1 . . . n} is sent to the invariant checker I to obtain per observation disagreements {dₖ, k in 1 . . . n} and overall disagreement—inconsistencies among {iₖ, k in 1 . . . n}: d^{c}. I's output are fed into the selector W to select one interpretation from one of the set of interpretations {iₖ, k in 1 . . . n} as output iₒᵤₜ. One implementation of I is to have a merging module M to get the average interpretation of {iₖ, k in 1 . . .n }: c; then a set of disagreement detectors {Dₖ, k in 1 . . . n} compare corresponding iₖ to c to get their distance Dₖ; the set of per observation disagreement {dₖ, k in 1 . . . n} is then fed into a module to do average P to get the overall disagreement d^{c}.

If dc is beyond a threshold that is pre-set or adjusted on-the-fly, the algorithm will start the process of reduction of inconsistency to drive down d^{c}. It will decide Oₖ is the next priority to dive into, so it expand the single observation into a set of observations with own invariant checker Iₖ and selector Wₖ, the same structure as it parent O, and correspondingly, the network enters into Sₖ state.

In Sₖ, it adapts itself to drive down its own overall disagreement dₖ^{c} (should be in the Oₖ module but due to space not shown on graph). If the disagreement is irreducible, it will then traverse back to state O by two alternative actions A₁ and A₂. Both A₁ and A₂ add a new observation Oₙ₊₁ to the set of observations. The difference is that A₁ will remove Oₖ (or Oₖ′) from the set of observations. The choice of A₁ or A₂ is determined by whether dₖ^{c} is beyond a threshold that is pre-set or adjusted on-the-fly (yes for A₁, otherwise for A₂).

Now it is assumed that the transition traverses back to the state O. If the updated overall disagreement d^{c}′ is still higher than threshold, the transition is caused to continue to conduct reduction of inconsistency. One possible action is to dive into an observation Oₗ other than Oₖ to reach the state Sₗ (not shown on the graph), or conduct the action A₂ to expand the observation set (stay in state O) in hope of reducing the overall disagreement.

On the other hand, Sₖ is a recursion of O, which means it can also pick one of its observations (say we pick Oₖ_{_}ₘ) and expand it, reaching the state S_{k m}. Note that we intentionally have Oₖ_{_}ₘ have its own internal structures: the target t will first be processed by a pre-processing observation Oₖ_{_}ₘ^{t} to produce a transformed target tₘ. Then another observation Oₖ (was used in top level state O, or any observation) takes the intermediate target tₘ and classify it to get an interpretation. Then the way to expand Oₖ_{_}ₘ is very similar to what we did in state Sₖ, except that the pre-processing observation Oₖ_{_}ₘ^{t} remains the same. As described above, observations can be chained together into a workflow to work together.

At any state (O, Sₖ or Sₖ_{_}ₘ), the process in the state diagram of FIG. 2 us caused to try its best to conduct reduction of inconsistency. However, there is a budget or constraint (e.g., timing, and the predefined resolution N) to limit the computation. If the current state has to stop due to any reason, it will treat the current overall disagreement as irreducible disagreement and exit to its parent state (or exit the program in the case of state O) through either A₁ or A₂, depending on whether the overall disagreement of current state is beyond its threshold (choose A₁) or not (choose A₂).

Back to state O, it is supposed after all the operations, the updated network results in an overall disagreement d^{c′} that is below its pre-set threshold, the top level interpretations reaches the status of consistent interpretations, therefore the output i′ₒᵤₜ can be accepted as the final output.

From a high level perspective, the transition starts from an initial set of observations (referred as the parent state), and checks for the consistency of their interpretations. If they are consistent, the result is obtained and the transition exits; otherwise, every individual observation is checked. When needed, the transition is expanded into a set of child observations (with sub-recognizers) to check consistency and simultaneously adapt the set to maximize the consistency, just like it were the parent state. If the set of child observations cannot get consistent, remove the parent observation from the parent state. After a parent observation's recursion completes, recruit new parent observations to the parent state, and get to the consistency check where the new cycle starts.

In AMN, a target is “a matter” or “stuff” that has independent feature representations on different observations (could be same feature extraction on different derivative images or data), with each observation having its own feature space, and being able to produce an independent interpretation of the target, the interpretations from different observations of a target should form a consensus to be qualified as an AMN target.

An AMN target is different from a random noise in that it has invariant properties carrying through different (valid) observations. For example, one can precisely recognize a character image no matter how challenge the task is (even in CAPTCHA) because it has invariant properties, which can be reliably captured by human visual perceptions that presumably employs a flexible set of “observations.” However, one cannot precisely define, identify or recognize an exact shape of a cloud because it changes from this moment to the next, with no stable shapes. Therefore a character is an AMN target, but an exact shape of a cloud is not.

To facilitate better understanding of the present invention, it deems necessary to provide a set of Questions & Answers. Without any inherent limitations, the answers are provided according to only one embodiment of the present invention.

Question 1: whether an exact shape of a cloud can be defined as an AMN target? (Exact shape with high resolution, not something vague such as a “mushroom-like shape”). Answer: no, cloud's exact shape change every second, you cannot find a stable exact shape over time that can be taken as an “invariant” property, not to mention that every cloud image has its own exact shape. As a result, a cloud exact shape fails to meet AMN target requirement that there are different observations to produce consistent interpretations for an invariant property.

Question 2: whether a cloud image (with either “this-is-a-cloud” or “this-is-not-a-cloud” label) can be defined as a AMN target? Answer: yes. A cloud image—if it is truly a cloud—has consistent properties (for example, color is white) over different observations, so we can get consistent classifications that this is a cloud. Therefore, it can be defined as AMN target.

Question 3: whether a sample in a pattern recognition task can be defined as an AMN target? Answer: yes. In all pattern recognition tasks, a sample is associated with an oracle label by definition. Therefore, there should exist some ideal (but different) classifiers that can output consistently its true label; therefore, it can be defined as AMN target. Most real world physical objects (doors, roads, cars, etc.) can fall into AMN target due to the fact that different perspectives to perceive them come to the same interpretation. If we imagine that each way of perception can be simulated by a software (observation), then the physical object is an AMN target.

AMN is a recognition process that aims for finding the invariant interpretations over a set of observations on an AMN target. It not only finds interpretations for a target as traditional pattern recognition does, it also makes sure those interpretations across different observations are consistent. If the algorithm cannot identify an AMN target in the input, it will adapt the set of observations until it can find one.

To recognize an AMN target, the prior knowledge is utilized that an AMN target should manifest its identities consistently over a sequence of valid observations, which is similar to WBR that all characters in a book abides to image homogeneity constraints. Therefore if current set of observations does not satisfy this prior knowledge, the set of observations is adjusted until this prior knowledge is satisfied.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The processes, sequences or steps and features discussed above are related to each other and each is believed independently novel in the art. The disclosed processes, sequences or steps and features may be performed alone or in any combination to provide a novel and unobvious system or a portion of a system. It should be understood that the processes, sequences or steps and features in combination yield an equally independently novel combination as well, even if combined in their broadest sense, i.e., with less than the specific manner in which each of the processes, sequences or steps and features has been reduced to practice.

The forgoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

We claim:

1. A method for generating recognizers for pattern recognition, the method comprising:
receiving in a computing device a set of initial recognizers, wherein the recognizers are generated from a set of training data not required to be representative of a set of actual data, each of the recognizers is dividable as a set of sub-recognizers and each of the sub-recognizers is further dividable as a set of next sub-recognizers till a predefined resolution on the recognizers;
performing observations on the set of input data received in the computing device in accordance with the recognizers; and
performing recursively and respectively subsequent observations with reduction of inconsistencies on each recursion level, when one of the observations is determined uncertain, wherein a recursion stops when a top level has a set of observations producing consistent interpretations on the set of input data.

2. The method as recited in claim 1, wherein the recognizers are recursively and respectively updated by discarding one or more of the recognizers, the sub-recognizers or the next sub-recognizers, and adding new recognizers, sub-recognizers or next sub-recognizers generated based on the input data.

3. The method as recited in claim 2, wherein the input data is obtained from actual data captured by a source, wherein the recognizers are used in the observation to determine a pattern from the actual data.

4. The method as recited in claim 3, wherein the source is an imaging capturing device.

5. The method as recited in claim 1, wherein the recognizers are generated to reduce the inconsistencies among the observations to produce better recognition accuracies.

6. The method as recited in claim 5, wherein said generating recursively and respectively subsequent observations with reduction of inconsistencies on each recursion level comprises: transforming the input data into a transformed data set to carry out an observation.

7. The method as recited in claim 4, further comprising:
determining a statistic measurement among the results from the observations;
performing a logical operation on the results from the observations with respect to the statistic measurement to produce respective disagreements from the observations; and
determining an overall disagreement for comparisons with the respective disagreements.

8. The method as recited in claim 7, wherein the statistic measurement is to determine a median among the results from the observations.

9. The method as recited in claim 8, wherein the logical operation is based on an XOR operator.

10. A computing device for generating recognizers for pattern recognition, the computing device comprising:
an input receiving a set of actual data;
a memory for storing code;
a processor, coupled to the memory, executing the code to cause the computing device to perform operations of:
loading a set of recognizers in the memory, wherein the recognizers are generated from a set of training data not required to be representative of the actual data, each of the recognizers representing one or more features that are supposed to describe the actual data, wherein each of the recognizers is represented in a tree structure with one node leading to multiple branches, each of the branches ends with a node;
performing observations on the set of input data received in the computing device in accordance with the recognizers to produce results from the observations;
when one of the observations is uncertain:
performing recursively and respectively subsequent observations with reduction of inconsistencies on each recursion level, wherein a recursion stops when a top level has a set of observations producing consistent interpretations on the set of input data.

11. The computing device as recited in claim 10, wherein the recognizers are recursively and respectively updated by discarding one or more of the recognizers, sub-recognizers or next sub-recognizers, and adding new recognizers, sub-recognizers or next sub-recognizers generated based on the input data.

12. The computing device as recited in claim 11, wherein the input data is obtained from actual data captured by a source, wherein the recognizers are used in the observation to determine a pattern from the actual data.

13. The computing device as recited in claim 12, wherein the source is an imaging capturing device.

14. The computing device as recited in claim 10, wherein the recognizers are generated to reduce the inconsistencies among the observations to produce better recognition accuracies.

15. The computing device as recited in claim 14, wherein said generating recursively and respectively subsequent observations with reduction of inconsistencies on each recursion level comprises: transforming the input data into a transformed data set to carry out an observation.

16. The computing device as recited in claim 13, further comprising:
determining a statistic measurement among the results from the observations;
performing a logical operation on the results from the observations with respect to the statistic measurement to produce respective disagreements from the observations; and
determining an overall disagreement for comparisons with the respective disagreements.

17. The computing device as recited in claim 16, wherein the statistic measurement is to determine a median among the results from the observations.

18. The computing device as recited in claim 17, wherein the logical operation is based on an XOR operator.
